(19) United States
(12) Patent Application Publication
(10) Pub. No.: US 2025/0139964 A1
(43) Pub. Date: May 1, 2025

(54) SYSTEMS AND METHODS FOR SURVEYING ROOFING STRUCTURES

(71) Applicant: CECC Maintenance Drone Co., Carp (CA)

(72) Inventors: Ernesto Robbie CECCHETTO, Ottawa (CA); Edward John VANDESANDE, Ottawa (CA); Nathaniel Alexander ROBB, Ottawa (CA); Derek Cameron Irvine BOASE, Ottawa (CA); Scott WALLIS, Ottawa (CA)

(21) Appl. No.: 18/495,249

(22) Filed: Oct. 26, 2023

(51) Int. Cl. G06V 20/17; G05D 1/10; G06T 7/00; G06V 10/764; G06V 20/10

(52) U.S. Cl. CPC G06V 20/17; G06T 7/0004; G06V 10/764; G06V 20/176; G06T 2207/10032; G06T 2207/20081; G06T 2207/30108

(57) ABSTRACT

Systems and methods for surveying roofing structures are disclosed. The method may include controlling a drone to fly along a first flight path in a direction over roofing structure of a site. A primary set of images of a first set of regions of the roofing structure is captured via at least one imaging device of the drone maintained in a first fixed pose relative to the roofing structure. The drone is controlled to fly along a second flight path over the roofing structure; capturing a secondary set of images of a second set of regions of the roofing structure via the at least one imaging device maintained in a second fixed pose relative to the roofing structure; storing and processing the primary set of images and the secondary set of images via the computing system to identify issues in the roofing structure of the site.

### TECHNICAL FIELD

The present disclosure relates to building maintenance, and, in particular, to systems and methods for surveying roofing structures.

### BACKGROUND

Roof surveying is presently performed by having a human mount on a roofing structure to be surveyed and use an imaging device, such as a camera of a mobile phone, to image the roofing structure where there are issues. As will be understood, this process is time consuming, dangerous, and subject to human error.

### SUMMARY

The present disclosure describes systems and methods which provide one or more efficient techniques to perform roofing structure surveys at a site.

In accordance with a first aspect of the present disclosure, there is provided a method for surveying roofing structures, comprising: controlling a drone to fly along a first flight path in a direction over roofing structure of a site; capturing a primary set of images of a first set of regions of the roofing structure of the site during flight of the drone along the first flight path via at least one imaging device of the drone maintained in a first fixed pose relative to the roofing structure; controlling the drone to fly along a second flight path over the roofing structure; capturing a secondary set of images of a second set of regions of the roofing structure during flight of the drone along the second flight path via the at least one imaging device of the drone maintained in a second fixed pose relative to the roofing structure; storing the primary set of images and the secondary set of images in memory of a computing system; and processing the primary set of images and the secondary set of images via the computing system to identify issues in the roofing structure of the site.

In some or all exemplary embodiments of the first aspect, the drone has a frame that is maintained in a fixed orientation during capture of the primary set of images, and a subset of the at least one imaging device is maintained in fixed orientation relative to the frame.

In some or all exemplary embodiments of the first aspect, the subset of the at least one imaging device is a first subset of the at least one imaging device, wherein the fixed orientation is a first fixed orientation, and a second subset of the at least one imaging device is maintained in a second fixed orientation relative to the frame.

In some or all exemplary embodiments of the first aspect, the at least one imaging device is reorientable, is configured in a first orientation relative to the frame during the first flight path, and is configured in a second orientation relative to the frame during a second flight path.

In some or all exemplary embodiments of the first aspect, the at least one imaging device is oriented downwards during the first flight path and the primary set of images are nadir images, and the at least one imaging device is oriented oblique to a vertical axis during the second flight path.

In a second aspect of the present disclosure, there is provided a system for surveying roofing structures, comprising: a drone having at least one imaging device; and a computing system having: at least one processor; storage storing computer-readable instructions that, when executed by the at least one processor, cause the at least one processor to control the drone to fly along a first flight path in a direction over roofing structure of a site, capture a primary set of images of a first set of regions of the roofing structure of the roofing structure during flight of the drone along the first flight path via the at least one imaging device of the drone maintained in a first fixed pose relative to the roofing structure, control the drone to fly along a second flight path over the roofing structure, and capture a secondary set of images of a second set of regions of the roofing structure during flight of the drone along the second flight path via the at least one imaging device of the drone maintained in a second fixed pose relative to the roofing structure.

In some or all exemplary embodiments of the second aspect, the computer-readable instructions, when executed by the at least one processor, cause the computing system to store the primary set of images and the secondary set of images in the storage, and process the primary set of images and the secondary set of images via the computing system to identify issues in the roofing structure of the site.

In some or all exemplary embodiments of the second aspect, the computer-readable instructions, when executed by the at least one processor, cause the computing system to control the drone to maintain a frame of the drone in a fixed orientation during capture of the primary set of images, and maintain a subset of the at least one imaging device i in fixed orientation relative to the frame.

In some or all exemplary embodiments of the second aspect, the subset of the at least one imaging device is a first subset of the at least one imaging device, the fixed orientation is a first fixed orientation, and the computer-readable instructions, when executed by the at least one processor, cause the computing system to control the drone to maintain a second subset of the at least one imaging device in a second fixed orientation relative to the frame.

In some or all exemplary embodiments of the second aspect, the at least one imaging device is reorientable, is configured in a first orientation relative to the frame during the first flight path, and is configured in a second orientation relative to the frame during a second flight path.

In some or all exemplary embodiments of the second aspect, the at least one imaging device is oriented downwards during the first flight path and the primary set of images are nadir images, and the at least one imaging device is oriented oblique to a vertical axis during the second flight path.

In a third aspect of the present disclosure, there is provided a computer-implemented method for surveying roofing structures, comprising: controlling a drone to fly over a roofing structure of a site; capturing a set of images of the roofing structure of the site via an imaging device of the drone; tagging roofing types in each of the set of images; and processing each image in a subset of the set of images tagged with a specific tag with a machine learning model trained for a corresponding one of the roofing types to identify issues with the roofing structure of the site.

In a fourth aspect of the present disclosure, there is provided a system for surveying roofing structures, comprising: a drone having at least one imaging device; and a computing system having: at least one processor; storage storing computer-readable instructions that, when executed by the at least one processor, cause the at least one processor to: control the drone to fly over a roofing structure of a site; capture a set of images of the roofing structure of the site via the at least one imaging device of the drone; tag roofing types in each of the set of images;

and process each image in a subset of the set of images tagged with a specific tag with a machine learning model trained for a corresponding one of the roofing types to identify issues with the roofing structure of the site.

In a fifth aspect of the present disclosure, there is provided a computer-implemented method for surveying roofing structures, comprising: controlling a drone to fly over a roofing structure of a site; capturing a set of images of the roofing structure of the site via an imaging device of the drone; processing each image in the set of images to identify and label features of the roofing structure in the set of images; and selecting a subset of the set of images for populating a report generated for the roofing structure.

In a sixth aspect of the present disclosure, there is provided a system for surveying roofing structures, comprising: a drone having at least one imaging device; and a computing system having: at least one processor; storage storing computer-readable instructions that, when executed by the at least one processor, cause the at least one processor to: control the drone to fly over a roofing structure of a site; capture a set of images of the roofing structure of the site via the at least one imaging device of the drone; process each image in the set of images to identify and label features of the roofing structure in the set of images; and select a subset of the set of images for populating a report generated for the roofing structure.

In a seventh aspect of the present disclosure, there is provided a computer-implemented method for surveying roofing structures, comprising: controlling a drone to fly over a roofing structure of a site; capturing a set of images of the roofing structure of the site via at least one imaging device of the drone; and processing each image in the set of images to identify and label features of the roofing structure in the set of images.

In an eighth aspect of the present disclosure, there is provided a system for surveying roofing structures, comprising: a drone having at least one imaging device; and a computing system having: at least one processor; storage storing computer-readable instructions that, when executed by the at least one processor, cause the at least one processor to: control a drone to fly over a roofing structure of a site; capture a set of images of the roofing structure of the site via at least one imaging device of the drone; and process each image in the set of images to identify and label features of the roofing structure in the set of images.

Other aspects and features of the present disclosure will become apparent to those of ordinary skill in the art upon review of the following description of specific implementations of the application in conjunction with the accompanying figures.

### BRIEF DESCRIPTION OF THE DRAWINGS

Reference will now be made, by way of example, to the accompanying drawings which show exemplary embodiments of the present application, and in which:

FIG. 1 is a schematic diagram of a system for surveying roofing structures and its operating environment in accordance with exemplary embodiments described herein.

FIG. 2 is a flowchart of a general method of surveying roofing structures in accordance with exemplary embodiments described herein.

FIG. 3 is a flowchart of a general process of determining whether a drone flight is legal during the method of FIG. 2 in accordance with some exemplary embodiments described herein.

FIG. 4 is a flowchart of a general process of mission planning during the method of FIG. 2 in accordance with some exemplary embodiments described herein.

FIG. 5 is a flowchart of a general process of the creation of a flight plan during the method of FIG. 4 in accordance with some exemplary embodiments described herein.

FIG. 6A is a top plan view of a roofing structure of a building and a primary flight path configured to capture a set of nadir images of the roofing structure.

FIG. 6B shows regions corresponding to boundaries for the set of nadir images to be captured during the flight path of FIG. 6A.

FIG. 6C to 6F show four secondary flight paths for capturing four sets of secondary images of the roofing structure of FIG. 6A at oblique angles.

FIG. 7 is a flowchart of a general process of flight/image capture during the method of FIG. 2 in accordance with some exemplary embodiments described herein.

FIG. 8 is a flowchart of a general process of image importing and sorting during the method of FIG. 2 in accordance with some exemplary embodiments described herein.

FIG. 9 is a flowchart of a general process of artificial intelligence (AI) processing during the method of FIG. 2 in accordance with some exemplary embodiments described herein.

FIG. 10 is a flowchart of a general process of AI prediction filtering during the method of FIG. 2 in accordance with some exemplary embodiments described herein.

FIG. 11A shows a set of labelled image regions in an image of a roofing structure corresponding to features (either roofing elements or issues identified by the trained models).

FIG. 11B shows the set of labelled image regions after aggregation via the approach of FIG. 10.

FIG. 12 is a flowchart of a general process of AI training during the method of FIG. 2 in accordance with some exemplary embodiments described herein.

FIG. 13 is a flowchart of a general process of report pre-processing during the method of FIG. 2 in accordance with some exemplary embodiments described herein.

FIG. 14 is a flowchart of a general process of automatic report generation during the method of FIG. 2 in accordance with some exemplary embodiments described herein.

FIG. 15 is a flowchart of a general process of report editing during the method of FIG. 2 in accordance with some exemplary embodiments described herein.

FIG. 16 is a schematic diagram illustrating various components of the server computing system of FIG. 1 in accordance with some exemplary embodiments described herein.

FIG. 17 is a schematic diagram of a system for surveying roofing structures and its operating environment in accordance with other exemplary embodiments.

Similar reference numerals may have been used in different figures to denote similar components. Unless otherwise specifically noted, articles depicted in the drawings are not necessarily drawn to scale.

### DETAILED DESCRIPTION OF EXEMPLARY EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although such functions are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except wherein indicated otherwise either explicitly or inherently by context.

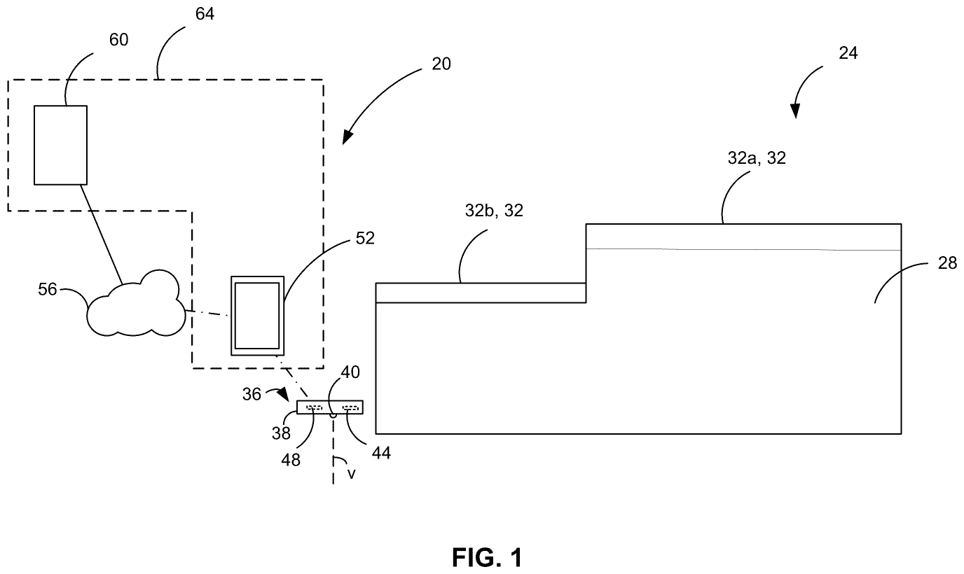

FIG. 1 is a schematic diagram of a system 20 for surveying roofing structures in accordance with exemplary embodiments described herein. The system 20 is used to survey roofing structures of a site 24. A site 24 can include one or more structures, such as buildings, barns, or any other structure that has one or more roofing structure that may require maintenance. In the illustrated example, the site 24 includes a single building 28, but, in other examples, the site can include two or more structures.

As used herein, the term “roofing structure” is a roof or roof portion that is of a particular roofing type. The illustrated building 28 is shown having two roofing types 32a, 32b, collectively referred to hereinafter as roofing types 32. Examples of different roofing types can include, but is not limited to, flat roofs, shingled sloped roofs, cedar roofs, metal flashing, siding, etc.

The system 20 includes a flying drone 36 that is remotely controlled by a pilot or autonomous. The drone 36 can be driven to fly via any suitable means, and commonly includes a set of four or more rotors that can be operated to control the elevation and lateral movement of the drone 36. The drone 36 includes a frame 38 and at least one imaging device 40 for capturing images of objects below the drone 36. In this particular illustrated embodiment, the at least one imaging device is a single imaging device 40 that is suitable for capturing digital images. In some embodiments, the images can include thermal scans and/or LiDAR data. The imaging device 40 can be angled in any direction up to at least 30 degrees from vertical v in the present embodiment, with either automatic or manual actuation of the imaging device 40. Images captured by the imaging device(s) 40 can be stored in a memory 44 of the drone 36. The memory 44 can be any suitable memory for storing digital images known to a person skilled in the art.

A communications module 48 of the drone 36 enables communication with a portable computing system 52 via any suitable wired or wireless communications network. While the portable computing device 52 illustrated is a tablet computer, other types of portable computing devices can be used, such as a laptop computer, a mobile phone, etc. In the embodiment illustrated in FIG. 1, the communications module 48 of the drone 36 is a wireless communications module that communicates with the portable computing device 52 via any suitable wireless standard, such as 802.11n, 802.11ac, etc.

The portable computing device 52 is configured to communicate via a communications network 56 such as the Internet with a server computing system 60. Communications between the portable computing device 52 and the communications network 56 can be conducted via any suitable type, and, in the illustrated embodiment, is performed via cellular communications.

While various functions are described herein as being performed by the portable computing system 52 or the server computing system 60, it will be understood that these functions and the corresponding data/models can be located as desired on the server computing system 60 and/or the portable computing system 52. Collectively, the portable computing system 52 and the server computing system 60 can be referenced as a computing system 64 that performs all of the functions that are performed by the portable computing system 52 and the server computing system 60 as described herein.

The computing system 64 communicates at least flight path data to the drone 36, and the drone 36 communicates captured image data to the computing system 64.

In other embodiments, however, the communications module 48 can be configured to communicate directly with the server computing system 60 via cellular communications networks, such as 5G and LTE, or via wired communications.

In still other embodiments, flight path data and image data can be transferred between the drone 36 and the computing system 64 via portable storage media.

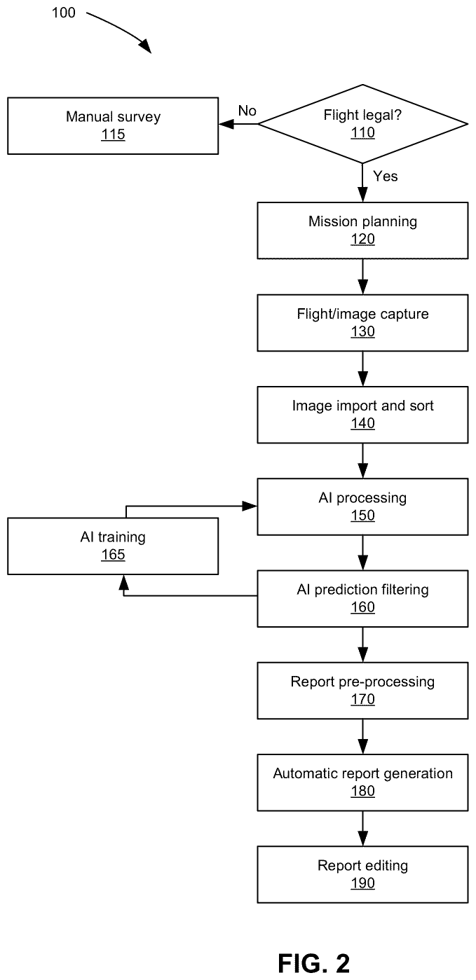

FIG. 2 is a flowchart of a general method 100 of surveying roofing structures in accordance with exemplary embodiments described herein. The method 100 commences with the determination of whether drone flight at the site is legal (110).

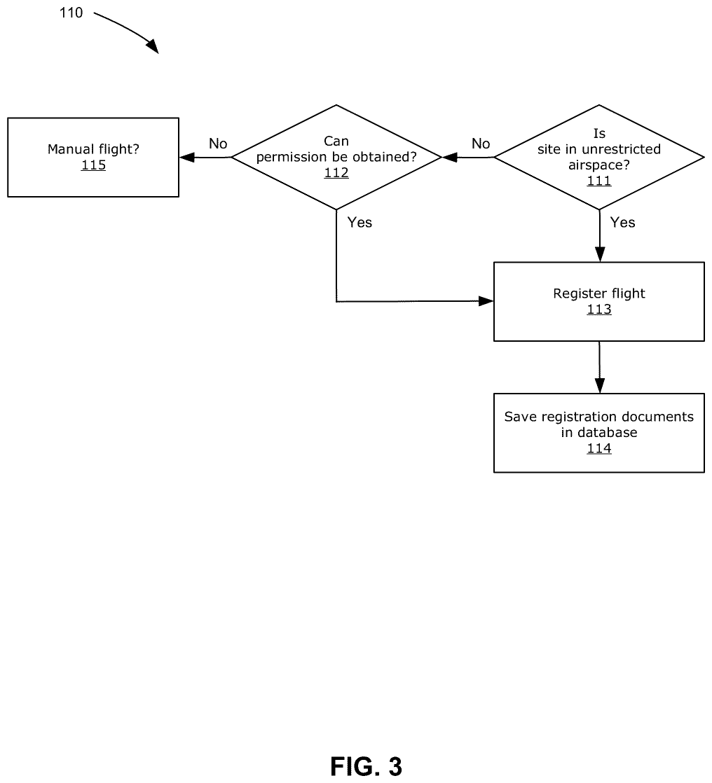

FIG. 3 illustrates the process 110 of determining whether drone flight at the site is legal in greater detail. The legality of drone flight is determined for the appropriate jurisdiction in which the site is located. For example, in Canada, to fly a drone weighing more than 250 g legally, the flight must be registered with NAV Canada at a minimum. To register a drone flight properly, it must meet all requirements in terms of drone type, pilot certification, and airspace restriction level. It is best practice to register drone flights with Transport Canada and the drone manufacturer as well to reduce the likelihood of geofence restriction errors on site during the flight. The computing system 64 can either be provisioned with the parameters of the regulations in effect for the location or can be in communication with other computing systems that can provide the regulations upon request. These parameters can then be used to determine whether drone flight at the site is legal. The location of the site can be determined in a variety of ways, such as manual selection/identification, IP address geomapping, global positioning system geolocation, etc.

During the process 110, it is determined if the site is in unrestricted airspace (111). If the site is not in unrestricted airspace, it is determined if permission to fly is obtainable for the site (112). If permission to fly is unobtainable for the site, a manual site roof survey can be discussed with the site owner (115). If it is determined that the building is in unrestricted airspace at 111, or if it is determined that permission can be obtained at 112, the drone flight is registered with one or more appropriate regulation authorities (113). While the site can be in unrestricted airspace, it can be beneficial to register the drone flight with the regulatory authorities, such as for insurance compliance purposes. Any registration documents provided or received can be registered in a documents database (114). All documentation is printed and kept on the person of the pilot at the time of the flight. With such documentation, the pilot is prepared for any potential interaction with authorities.

Returning to FIG. 2, once the legality of drone flight has been confirmed, the mission is planned (120).

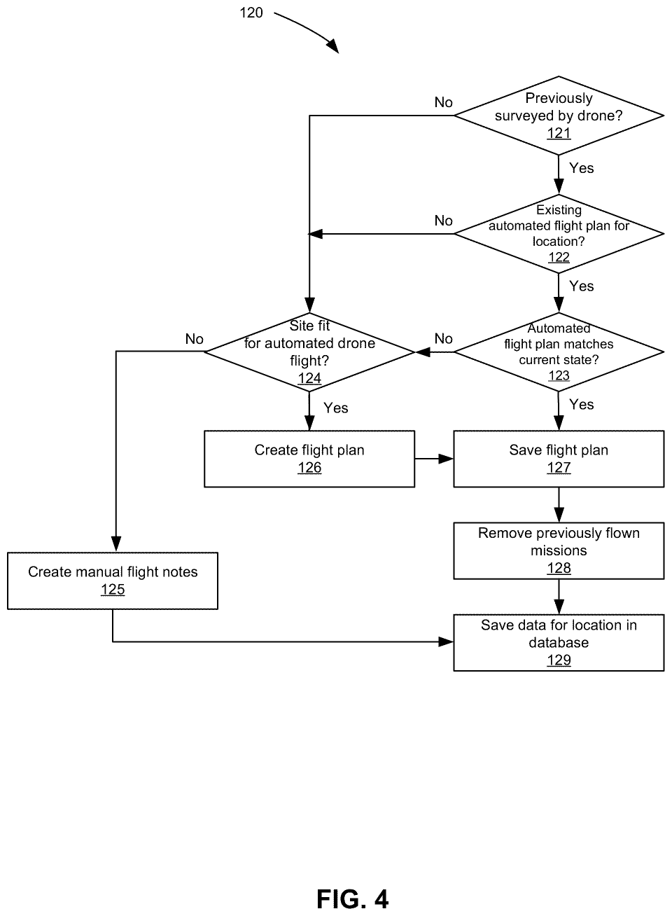

FIG. 4 shows the process 120 of mission planning performed by the computing system 64 in greater detail. Conventional surveying that is carried out on roofing structures at large sites is error prone due the sheer size of the area to be surveyed. For example, the repetitious nature of a rooftop unit (RTU) placement can cause certain areas to be overlooked in error, or the duration of the survey can also result in fatigue, further causing issues to be overlooked. Automated drone flight ensures that all areas of the roof are covered, and in an orderly efficient manner.

It's determined if the site has previously been surveyed by drone (121). If historical data in a flight database is searched to determine if a drone roofing survey has been previously completed. If it is determined that the site has previously been surveyed by drone surveys at 121, it is determined if the historical data includes an automated flight plan for the site (122). If an automated flight plan is available in the historical data in the flight database, the suitability of the automated flight plan can be determined by comparing it to the current site state (123). Where an automated drone survey has been previously performed for the site, the historical data can include the flight plan that can be reviewed to determine its suitability for use again, thus saving effort. For locations that have been surveyed previously, then the data used at the most recent survey should be verified for accuracy. If there are any discrepancies, then the data should be updated. That is, if any changes to the site have occurred since the last survey, or if flight restrictions have changed since the last survey, the changes can be reviewed to determine if the flight plan for the previously performed survey are still valid.

If the site has not been previously surveyed, or a flight plan is unavailable for the site, or if the stored flight plan is no longer suitable for current site state, it is determined if the site is fit for automated drone flight (124). To be fit for automated flight, the site must:
be free of obstructions in the airspace to be occupied by the drone,
be large enough to warrant using a grid pattern to fly over the area of the roofing structures, and
have network access to communicate with the computing system holding the flight path data.
   As will be understood, where storage media are used to transfer flight path data and imaging data between the drone 52 and the computing system 64, then the last condition may be omitted.

If one or more for the criteria above is not met at 124, then manual flight is deemed necessary for the site (125). A manual drone flight is still significantly more time efficient than conventional surveying on foot and benefits from many of the same assets as automated drone flight. Notes are created for manual flights and stored in a site notes database to aid a future pilot when surveying the same site. These notes are made available to the pilot for review prior to their flight of the site. They may contain information such as, but not limited to, obstructions to avoid, which drone was used previously, estimated time of survey, number of batteries required etc.

If it is determined at 124 that the site is fit for automated drone flight, a flight plan is created for the site (126). The flight plan provides instructions to the drone 52 on the specific path to fly with the points and angles for capturing each image or data from specific sensors, also incorporating any relevant flight restrictions. The flight plan is created by an experienced drone operator familiar with the standard requirements for image capture, and based on available information from sources such as available satellite imaging data, plus navigation information from sources such as NavCan. The previously performed flight plan determined to be suitable at 125 or the flight plan newly created for the site at 126 are then saved (127). Previously flown missions are then removed (128). Any out-of-date flight plan data is removed from the flight database. The flight plan is then saved for the site in the flight database (129).

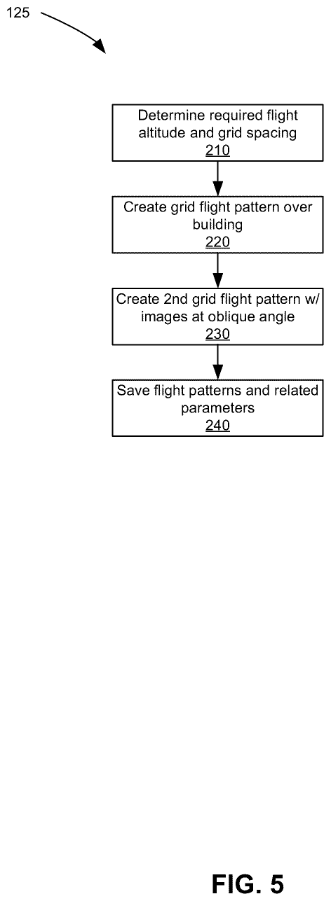

FIG. 5 is a flowchart of the general process 126 of the creation of a flight plan by the computing system 64 during the method 120 of FIG. 4 that captures effective images for processing by machine learning analysis.

When conventional means are used to survey the roof, a technician with inexperience or bias may overlook issues that are present. One of the primary benefits of the disclosed approach is that it retains no bias and is data driven. Any issues recognized by the system are reported along with their associated confidence. However, to identify all potential issues on a roof through means of image analysis, it is imperative that no area is missed during the capture phase. To ensure proper coverage, the images of a primary data set are taken by automated drone with a controlled overlap. In practice, the distance from subject (i.e., the roofing structures) to camera and the flight grid spacing are the two parameters that affect the amount of overlap in the images captured. As such, during mission planning, the desired overlap is set as a percentage of the image width and height, and the two parameters are calculated from the following:
building height (may be estimated from the number of floors×the average floor height);
drone altitude with respect to the roof; and
drone camera field of view.

During creation of the flight plan, the required flight altitude and grid spacing are determined (210). As will be understood, the area captured by the imaging device 40 in each image generally depends on (for a flat roof) the field of view of the imaging device 40 and the distance between the imaging device 40 and the roofing structure 32. For sloped roofing regions, the flight plan may or may not include changes in elevation over the sloped roofing regions, depending on the gradient of the slope. Roofing elevation can be determined using third-party photogrammetry, where possible.

Using the flight altitude and grid spacing determined at 210, a primary grid flight path is created over the site using automated flight parameters that are calculated based on building geometry (220). This primary grid flight path is used to fly the drone to capture a primary set of nadir images for analysis by the server computing system 40. Crucially, the primary set of images will all share the same heading, meaning that the drone will have generally the same pose when each of the primary set of images are captured. This consistency reduces variance in the content of the image, yielding higher confidence during problem identification in analysis. Additionally, it allows for issues identified in one image in the primary set to be located relative to neighbouring images in the primary set. This further permits the finding and removal of duplicate detections of the same instance of an issue across two or more neighbouring images.

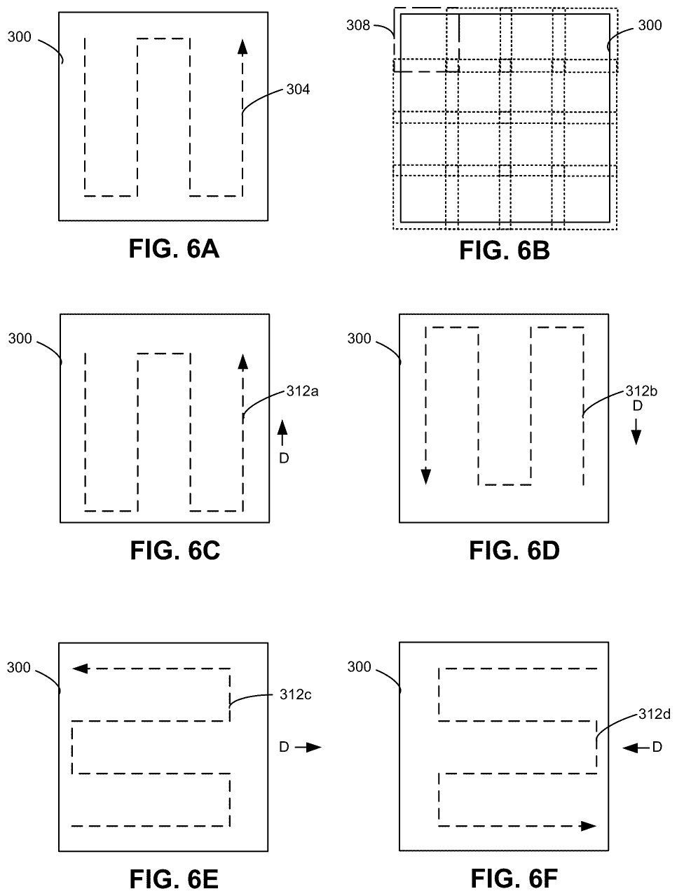

FIG. 6A shows a first flight path 304 of a flight plan over a roofing structure 300. As can be seen, the flight path follows a grid-like pattern, with the drone 52 maintaining a constant orientation over the entire first flight path 304. FIG. 6B shows a set of planned overlapping image regions, commencing with a first image region 308 corresponding to a first image to be captured. The imaging device 40 is maintained in a first fixed pose relative to a roofing structure being imaged. In particular, the imaging device 40 is directed vertically downwards and the pose of the drone 36 is maintained as the drone 36 performs the first flight path 304.

Next, one or more secondary flight paths to capture a secondary set of images at an oblique angle is planned (230). The secondary set of images is used to augment the findings of the primary set of images. For each grid point in the secondary flight path, images are captured at a specified oblique angle, and at multiple equally spaced headings. That is, the imaging device 40 is maintained in a second pose at an angle oblique from vertical relative to the frame 38, and the drone 36 is maintained in a single pose relative to the roofing structure as the secondary flight path is performed. This secondary flight path ensures that any point on the roof is captured from multiple vantages. The resulting secondary set of images may be used in the report to provide a clearer depiction of the issues present in the primary set of nadir images. In the embodiment(s) where the at least one imaging device includes one or more imaging devices fixed in pose relative to the frame of the drone, a different one of the one or more imaging devices can be employed when it is desired to capture images from a different angle.

In the present embodiment, four secondary flight paths shown in FIGS. 6C to 6F are planned to capture four secondary sets of images. Each of the four secondary sets of images are captured using a different angle of inclination of the imaging device 40. It will be appreciated that the secondary sets of images are intended to cover the same general regions as the first set of images, but that there are variances in the regions imaged due to the perspective differences. The imaging device 40 is angled 30 degrees from vertical in the direction D. Each of the secondary flight paths is offset from the primary flight path so that the imaging device 40 angled 30 degrees from vertical in the direction D generally captures images of the same image regions as shown in FIG. 6B. The result of these four secondary flight paths 312a to 312d is a set of five images of each image region: one nadir image and four angled images from each of four 30 degree angles, each being offset by 90 degrees from one another. This will allow features (including issues) to be more readily identified in at least one of the five images of each image region.

The primary and secondary flight paths and the associated offsets, altitude adjustments, and oblique angles are then saved in the flight database (240). There are several parameters that must be stored and applied on a per mission basis that are used to increase the mission accuracy and repeatability. These parameters can include, but are not limited to, latitude/longitude offsets, altitude offset and custom flight paths for object avoidance. This data must be updated each time the survey is used. For regular surveys at a given location, these parameters ensure consistency in the data acquired helping to better identify dynamic issues that should be monitored over time. Dynamic issues are identified and labelled issues (problems identified on the roof like deteriorating shingles) that do not require immediate attention, but should be monitored (e.g., annually or bi-annually) to identify when they should be fixed. It is desired to optimize the flight path on a per-site basis.

In some alternative embodiments, the at least one imaging device can include at least one imaging device configured to image in each of the downward vertical direction and one or more directions oblique to vertical.

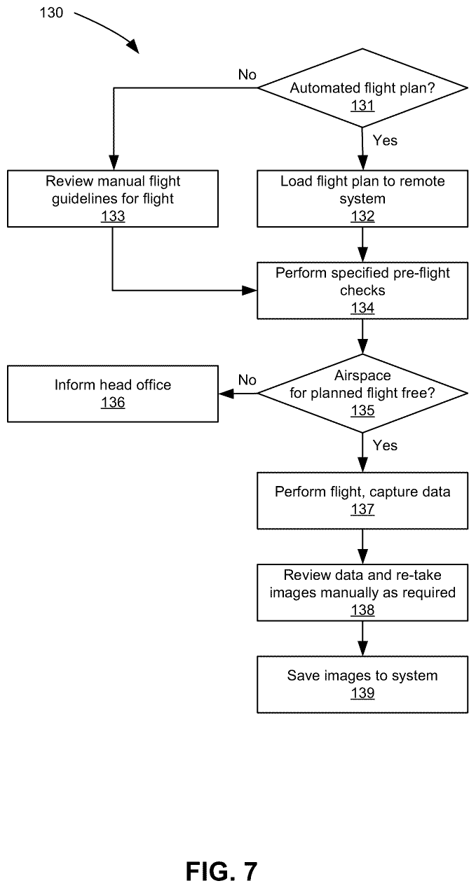

FIG. 7 is a flowchart of a general process of flight/image capture 130 during the method 100 of FIG. 2 in accordance with some exemplary embodiments described herein. It is beneficial to report any previously unidentified obstructions found in the flight path. Using this information, the data on file in the flight database can be updated to reflect the obstructions' presence. If an automated drone flight is used, then the flight path may have to be adjusted to circumvent the obstructions, depending on the obstructions' size and position. If the obstruction makes capturing the required data impossible or impractical by drone, then a manual survey can be performed or the roof structure survey can be cancelled. If the mission is manually flown, then the obstruction should be noted in the manual flight notes associated with this survey for review by future pilots.

It is critical that the images be reviewed after flight to ensure all proper data was captured. Any corrupt files or obstructed views will be of no use at the analysis stage, and replacement images should be taken while the pilot is still on site.

During flight/image capture 130, it's determined if the survey is to be performed by automated flight (131). If the survey is to be performed by automatic flight, the primary and secondary flight paths/plans are communicated to the drone 36 (132). If, instead, the survey is to be performed by a manual flight, the manual flight guidelines are reviewed (133). Regardless of whether the survey is performed by automated flight, a set of pre-flight checks are performed (134). It is then determined if the airspace for the planned flight is free (135). If the airspace is not free, head office is informed (136). If, instead, the airspace for the planned flight is free, the flight according to the primary flight path and the secondary flight path is performed, and images are captured during the primary flight path and the secondary flight path (137). The data is reviewed and images are re-taken manually, as required (138). Where an image is deemed to be unsuitable (e.g., unanticipated shadows due to the time of day of the survey, unexpected obstructions, etc.), the drone may be either manually or automatically guided to the location at which the image was taken for re-taking of the image. Once all of the desired images are captured and validated, the images are saved to the server computing system (139). As will be understood, each image is tagged with its location in the flight paths.

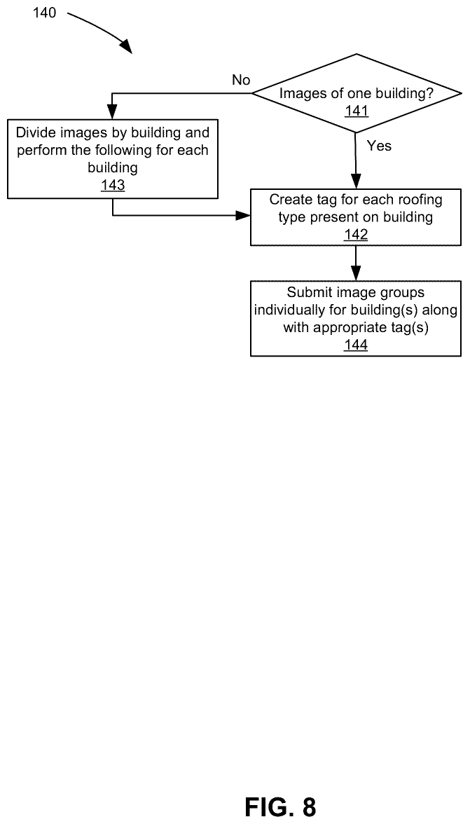

FIG. 8 is a flowchart of a general process 140 of image importing and sorting for the analysis stage performed using the server computing system 56 during the method 100 of FIG. 2 in accordance with some exemplary embodiments described herein. This stage is critical as it provides categorization information that is used in the remaining steps by the automated system to handle the data correctly. If there are multiple buildings present in a single survey, then images are separated into groups, with each group corresponding to a building. The automated report generation system uses this information to group the images appropriately in the report. All roof types present in a group are then tagged. If there are multiple roof types present on a single building, then multiple roofing type metadata tags can be added to each image in the group. This information is used to facilitate processing the images with the correct AI models.

The process 140 commences with the determination of whether the primary set of images are of one or more buildings (141). A building is a contiguous structure. If it is determined that there is only one building, a roofing type metadata tag is created for each roofing type present on the building (142). If, instead, it is determined that there are two or more buildings at 141, then the images are grouped by building, and, for each building, a metadata tag is created for each roofing type present on the building at 142. The image groups are submitted individually for each building along with the appropriate metadata tag(s).

During issue identification, the images are processed through the relevant AI model(s) which are trained to identify and label specific issues by roofing type. The label consists of a box drawn around the identified issue, the name of the issue (e.g., ‘missing shingle’), and a percentage confidence rating, as described hereinbelow. By using a model that is trained for the particular roofing type, the model can more accurately identify issues in images of portions of the roofing structure of the particular roofing type. This is repeated for each metadata tag; that is, for each roofing type.

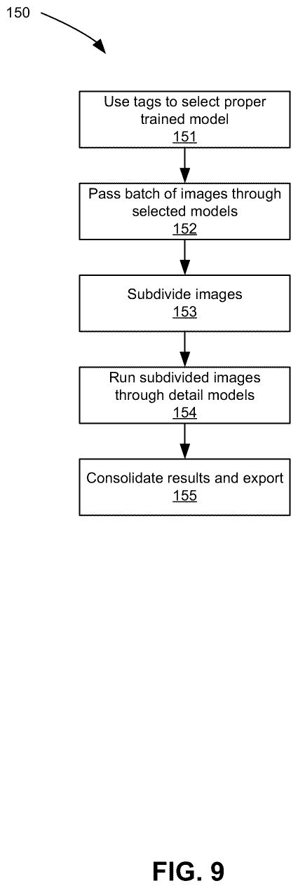

FIG. 9 is a flowchart of a general process 150 of issue identification analysis of the captured and labeled images during the method 100 of FIG. 2 in accordance with some exemplary embodiments described herein.

During the AI training process performed in advance of processing images, models are generated for each unique roofing type. This results in higher accuracy in fewer training iterations. As such, the data processed by the models is sorted in the same fashion. Roofing type metadata tags are applied in the previous step of the overall process, “Import and Sort”. These tags identify the type of roofing present in the survey and are used to load the proper models for each image in the survey (151). If there are multiple roofing types present in a group of images, all images in the group are passed through all relevant models. The images are then analyzed using the selected trained AI models to identify issues (152). Where an image is tagged with two or more metadata tags, the image is analyzed using each of the corresponding trained AI models. The images are then subdivided to enhance detail after compression and look for features that are typically smaller in the image (153). The subdivided images are then run through detail models (154). Results from all models are in the form of labelled bounding boxes, with pixel coordinates describing the location in their parent image and a percentage score describing the confidence the AI model had in its labeling of the issue (feature). The results of the models for each image are then consolidated and exported for use in the next step, AI result filtering (155).

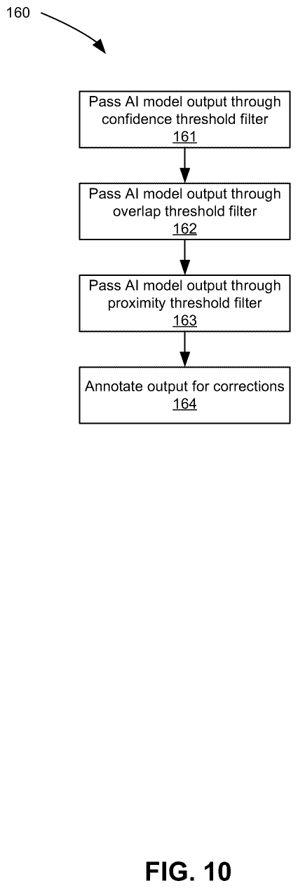

FIG. 10 is a flowchart of a general process 160 of AI prediction filtering during the method 100 of FIG. 2 in accordance with some exemplary embodiments described herein. During AI prediction filtering, the output of the trained AI models is filtered in preparation for use in the report to the client. There are four main steps used in this approach.

First, the model results are passed through a confidence threshold filter (161). This confidence threshold filter eliminates any issues/features that have been estimated by an AI model with a confidence lower than the set threshold. This threshold is set to a default value based on the running average of previous values used. However, the confidence threshold can be overridden by a user. Any user override is recorded and incorporated into the running average to improve the model.

The second step is to pass the results of the first step into an overlap threshold filter (162). This overlap threshold filter is used to combine clusters of labels into single larger labels. A cluster is a group of labels that share the same name and occupy the same area of the parent image. The “overlap” is calculated as an intersection over union between labels of the same name. If the result is over the set overlap threshold, then a “connection” is made, and the bounding boxes will be replaced by a larger bounding box. Furthermore, if there are multiple connections between a group of bounding boxes, then they are considered to be a “chain”, and all elements of the chain are replaced by a large bounding box whose coordinates are set using the furthest extents of any members in the chain. Any bounding box formed of two or more overlapping bounding boxes will maintain the highest confidence score out of those which it is replacing.

The third step applies a proximity threshold filter (163). This proximity threshold filter is used in a manner similar to the overlap threshold filter, but is based on the proximity of bounding boxes. The results of the overlap filter are passed through this proximity threshold filter to join any chains that are close to one another, but do not touch. This can help to further declutter the results, preparing them for use in the report.

The final step is to take the output of the three previous filters and review them in an image annotation software to make any final corrections (164). These corrections could be mislabeled or overlooked issues/features present in the image. The result should be an error-free annotation of the image. With further development in the model, the number of corrections required is expected to diminish, and this step may eventually be removed altogether. The filtered and corrected results are then used in report pre-processing and are added to the training set for developing the AI models further.

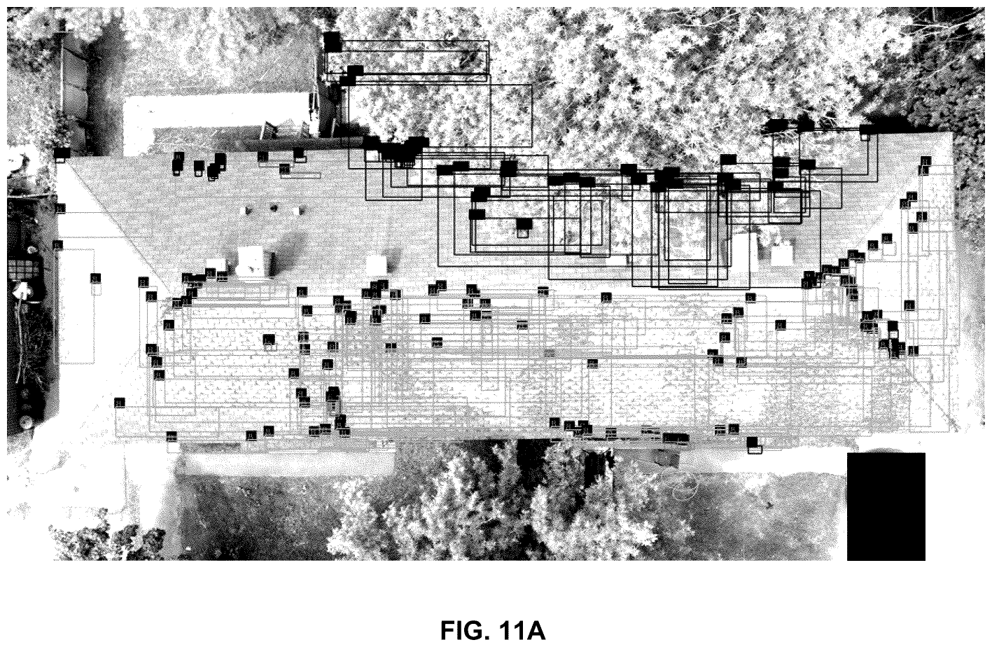

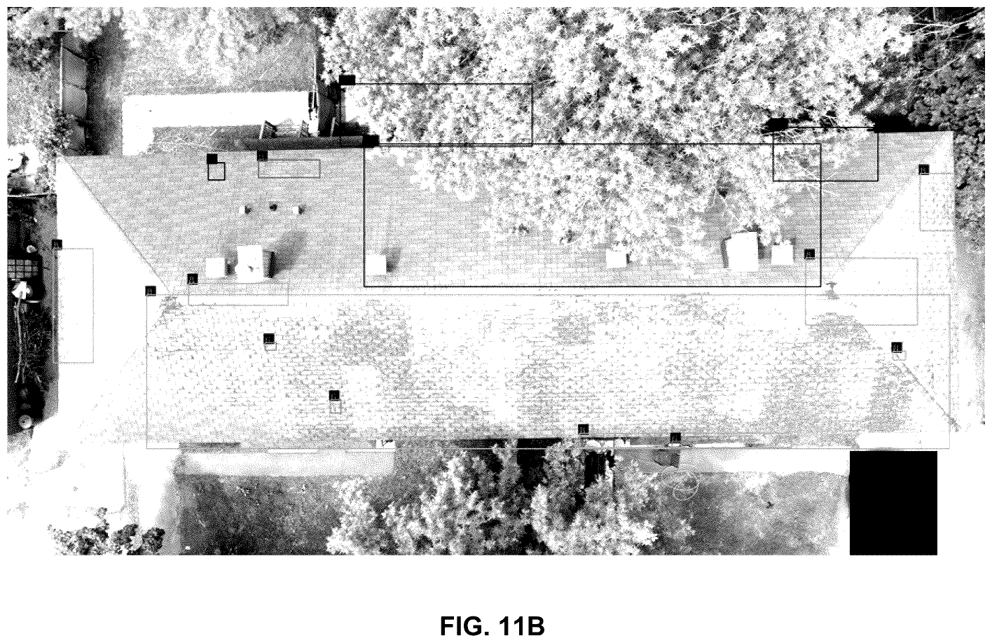

FIG. 11A shows a set of labelled image regions in an image of a roofing structure denoted with rectangles with black squares in the upper-left corners corresponding to features (either roofing elements or issues) identified by the trained models. As will be understood, the issue regions identified and labeled by the models are quite granular.

FIG. 11B shows the set of labelled image regions after aggregation via the approach of FIG. 10. Granular regions are grouped and represented as larger labeled regions to represent the issues via larger, general areas that can be more readily understood by a person viewing the image.

During the process of capturing and processing images to identify and label roofing issues in the images, the labeled images are fed back into the training dataset for the AI models for each roofing type to improve the AI models via further training.

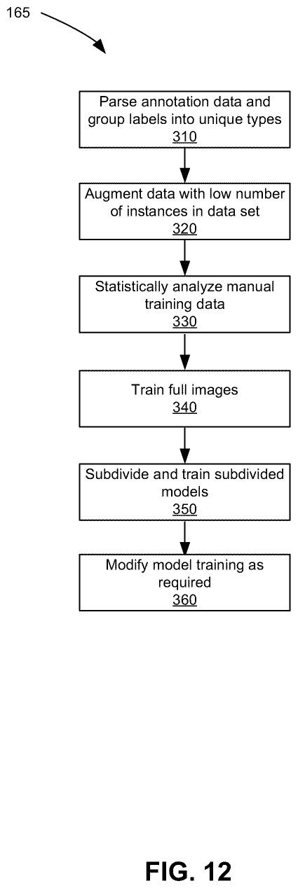

FIG. 12 shows a general process 165 of training of the AI models, both prior to the use of the AI models and during use of the AI models using the labeled images with identified roofing issues in accordance with some exemplary embodiments described herein. The images for the different roofing types that may have or may not have roofing issues identified and labeled therein are fed to an AI model trained for the corresponding roofing type.

The process commences with the parsing of the annotation data and group labels into unique types (310). As described earlier, the annotation data is parsed into unique label types. By allowing the AI model to learn fewer label types at a time, model confidence is increased. Furthermore, models have been separated by roofing type to also help boost accuracy and confidence of model predictions.

Next, the data with a low number of instances in the data set is augmented (320). This step is generally only performed prior to initial use of the AI models to ensure that the AI models have a sufficient basis for classifying features (issues). Where the number of examples for a particular issue (label) are few in the training data, image augmentation is used to artificially increase the number of examples in the data set. The process of augmentation is to create altered copies of the original dataset. These alterations could include flipping the images, rotating them, stretching, or skewing the content, changing the colour etc. The additional examples the augmentation provides enables the model to learn these traits effectively, without the need to acquire more data and manually label it.

Statistical analysis of the manual training data is then performed to determine the number of models and any biases to be trained into the models (330). Underlying trends that emerge from this statistical analysis are used to create data groups and influence the training process of a model such that it will tend to identify features that follow the trend. The trends identified could include, but are not limited to, similarities in both size and aspect ratios of bounding boxes on a per label type basis. As a result of these trends, issue types may be grouped to reduce the number of AI models to identify the issue types, with one model being trained for each issue type or group of issue types.

The primary goal for each AI model developed is maximum accuracy. There are many input parameters that can influence a model's ability to identify features in an image correctly. Through statistical analysis of manually annotated data sets, it is possible to identify trends that highlight common characteristics of correctly annotated features. These characteristics might include, but are not limited to, sizes or aspect ratios associated with different feature types. Once identified, these can be used to influence the training process such that the final model tends to make estimates that follow the trend. For example, the correlation of annotation size (area on image) and feature type can be used to determine which features generally have large, medium or small boxes. A positive bias can then be introduced into the model such that it will have increased confidence in its identification of a feature when that annotation matches the expected size. Finally, grouping annotation types that share similar bias into a single model can increase process efficiency by using one model to identify multiple traits while maintaining high accuracy.

The full images are then used to train the AI models (340). The number of AI models and any biases determined at 330 are used here. Where the method 165 is being performed during processing of a set of images from an actual site after pre-training of the AI models, the labeling results from the set of images are used to augment the training of the AI models.

The images are then subdivided for detail training of the models (350). Training an AI model can be memory intensive, and as such there is a limitation on the size of the images processed. To accommodate images that are larger than the limitation, these images are compressed before being passed into the model. Raw images taken by the drone are of relatively large resolution and typically get compressed by a substantial degree before being passed into the model. As such, much of the finer detail is lost before the model analyses the image. This results in smaller features being overlooked by the AI when they would otherwise be reported. To address this, the images are subdivided, and passed through one subdivision at a time. The smaller subdivisions are compressed far less and retain much of the original detail. This allows for the identification of smaller features. Larger features can be cut irregularly by the subdivision process, and therefore can be overlooked in the subdivided model. It is best then to have the combination of the two approaches.

Finally, the model training is then modified as required (360). Finally, the results from training are observed by the developer, and changes to the input are made with the intent to improve the model further. These changes can include but are not limited to:
omission of features for which there is insufficient data;
augmenting the data further to help with features that have fewer examples;
merging of models where the traits are performing well on their own, to reduce the processing time required during evaluation;
altering the size of the subdivisions used, to balance detail and processing speed; and
selections of a different pre-trained AI model architecture.
   Where appropriate, models trained from scratch can be generated to yield improved results. These models can be created when required.

This process is repeated until the best results for the dataset on hand are achieved.

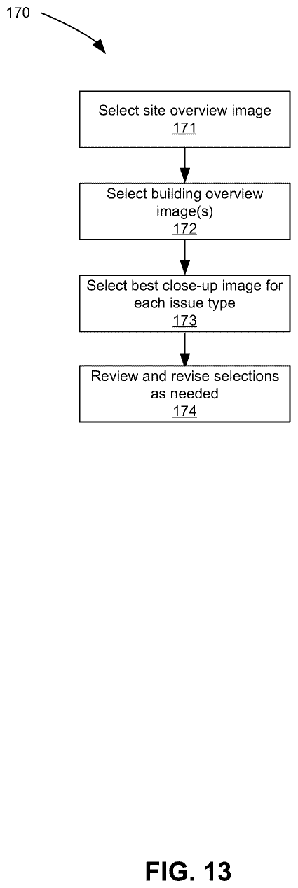

FIG. 13 is a flowchart of a general process 170 of report pre-processing the data from the roofing structure survey to be processed by the automatic report generator during the method 100 of FIG. 2 in accordance with some exemplary embodiments described herein. To facilitate the use of an automatic report writing process, it is critical that the data used as input be properly conditioned. Part of this conditioning occurs during the AI prediction filtering. This step ensures that the annotations used in the report are accurate. It also ensures that the data is ready to be used for further AI training.

The pre-processing that occurs involves categorizing the images present in a single survey. There are four categories of image in the report. The images that belong in each need to be specified (either directly or indirectly depending on the category) prior to the images being submitted to the automatic report generator. The categories are as follows.
Site overview image: In this image, the entire location of the site must be represented. Furthermore, the location of the building(s) is/are specified within the image. There is one site overview image per survey, and it is selected by a user.
Building overview image: This is an overview of the building. It is used to map the locations of the issues in later images to their location on the roof. The images are grouped by building at an earlier stage (Image Import and Sort), and as such only one building overview image is selected per group.
Choice example image: There is one choice example per issue type present in a survey. This choice example is highlighted in the image and a closeup is shown to provide the client with suitable detail of the issue. The choice examples used are selected based on highest confidence example in the batch of that label type for the survey. The user may override this choice.
Alternate image: These are the remaining images that offer alternate perspectives of issues on the roof and can be used as source material for choice example close ups.

The image categorization process provides the automatic report generation tool the data it needs to write the report and is much faster than writing a report manually. With more training on new models, eventually much of the manual effort will be reduced further or removed entirely.

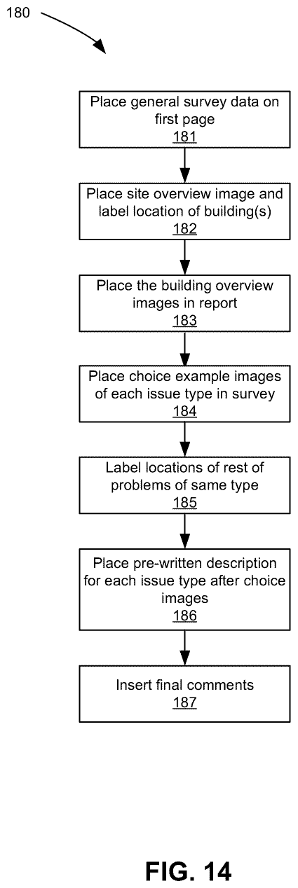

FIG. 14 is a flowchart of a general process 180 of automatic report generation during the method of FIG. 2 in accordance with some exemplary embodiments described herein. The data has been captured by the drone, analyzed by the AI, filtered for bounding box confidence, overlap and proximity, corrected for error with manual review, categorized into site overview images, building overview image, choice example images, and remaining examples. After these steps the data is considered error free and ready for use in automatic report generation.

The process 180 for generating the report commences with taking the general survey data from the data base and filling out the first page (181). The site overview image is placed and the locations of the buildings with bounding boxes on the image are labeled (182). The building overview image(s) are placed in the report (183). The choice example image for each issue type is placed under each building overview image (184). All bounding boxes for the issue type, including the choice example, are then labeled (185). The choice example bounding boxes are extracted and displayed enlarged for clarity. The corresponding pre-written description for the image type that it highlights is placed under each choice example image (186). Any final comments are then inserted in the report (187).

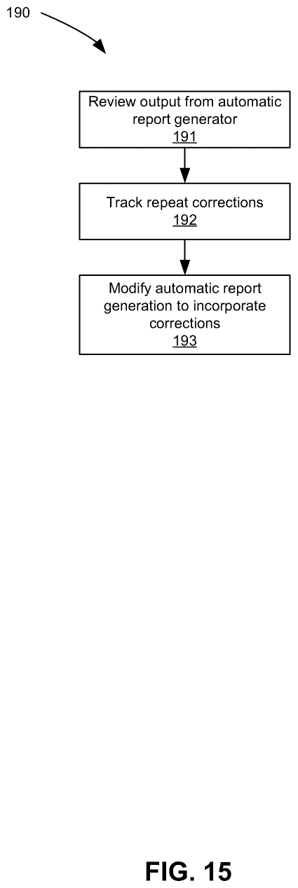

FIG. 15 is a flowchart of a general process 190 of report editing during the method of FIG. 2 in accordance with some exemplary embodiments described herein. During report editing, the automatically generated report is verified by a human. During the review process 190, any necessary corrections are made to the final report, ensuring that it is error free before delivering it to the client (191). Repetitious errors are tracked (192). Finally, the automatic report generator is modified to incorporate corrections for the repetitious errors (193).

Conventional reporting is subject to the bias of technician and the writer. The use of an automated report generator helps to remove this bias and ensure that all claims in the report are backed up by the data that is presented alongside them. This ensures consistent results across all reports for all clients.

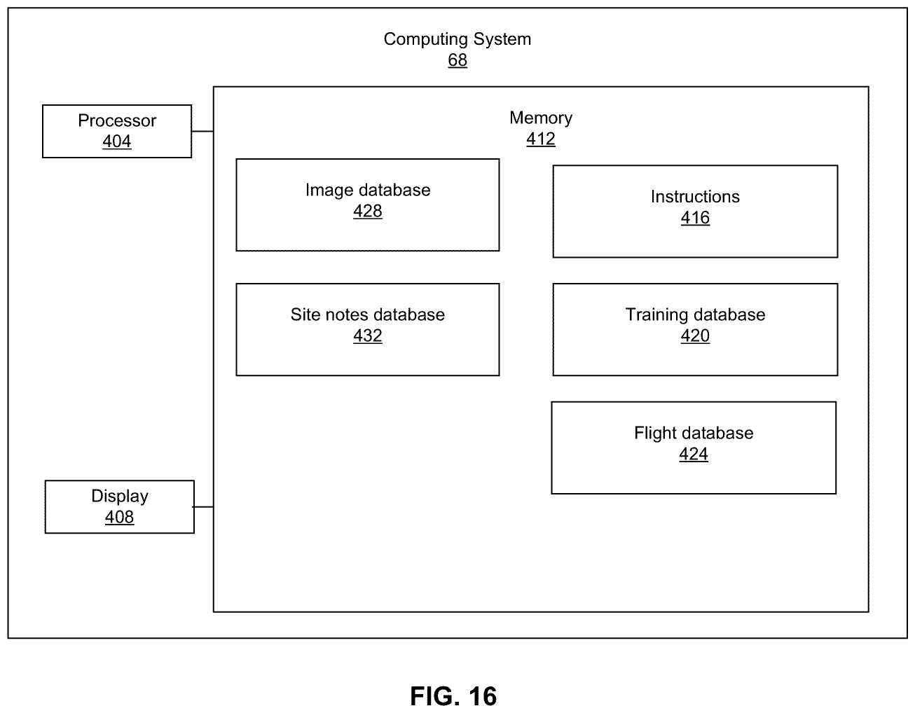

FIG. 16 shows various physical and logical components of an exemplary computing system 64 for managing the roof surveying process in accordance with an embodiment of the present disclosure. As noted herein, the computing system can be one or both of the server computing system 60 and the portable computing system 52 acting in cooperation. Although an exemplary embodiment of the computing system 64 is shown and discussed below, other embodiments may be used to implement examples disclosed herein, which may include components different from those shown. Although FIG. 16 shows a single instance of each component of the computing system 64, there may be multiple instances of each component shown.

The computing system 64 includes one or more processors 404, such as a central processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 404 may collectively be referred to as a processor 404. The computing system 64 may include a display 408 for outputting data and/or information in some applications, but may not in some other applications.

The computing system 64 includes one or more memories 412 (collectively referred to as “memory 412”), which may include a volatile or non-volatile memory (e.g., a flash memory, a random access memory (RAM), and/or a read-only memory (ROM)). The non-transitory memory 412 may store machine-executable instructions for execution by the processor 404. A set of machine-executable instructions 416 defining a system for surveying roofs and generating reports (described herein) is shown stored in the memory 412, which may be executed by the processor 404 to perform the steps of the method 100 described herein. The memory 412 may include other machine-executable instructions for execution by the processor 404, such as machine-executable instructions for implementing an operating system and other applications or functions.

The memory 412 stores a training database 420 that includes labeled training images used to train the AI models to identify issues/features in images of roofing structures as described herein.

The memory 408 also stores a flight database 424 that houses the most recent flight paths for each site. The flight database 424 can also include previous flight paths for sites. An image database 428 includes images captured during current and recent surveys, including the images captured and analyzed during production of a report. A site notes database 432 stores site notes made by pilots and other surveyors for sites.

In some examples, the computing system 64 may also include one or more electronic storage units (not shown), such as a solid state drive, a hard disk drive, a magnetic disk drive and/or an optical disk drive. In some examples, one or more datasets and/or modules may be provided by an external memory (e.g., an external drive in wired or wireless communication with the computing system 64) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 412 to implement data storage, retrieval, and caching functions of the computing system 64.

The components of the computing system 64 may communicate with each other via a bus, for example. In some embodiments, the computing system 64 is a distributed computing system and may include multiple computing devices in communication with each other over a network, such as the portable computing system 52 and the server computing system 60, as well as optionally one or more additional components. The various operations described herein may be performed by different computing devices of a distributed system in some embodiments. In some embodiments, the computing system 64 is a virtual machine provided by a cloud computing platform.

Although the components are shown as part of the single unit computing system 64, it will be understood that separate computing devices can provide the same functionality and form part of a system for doing the same.

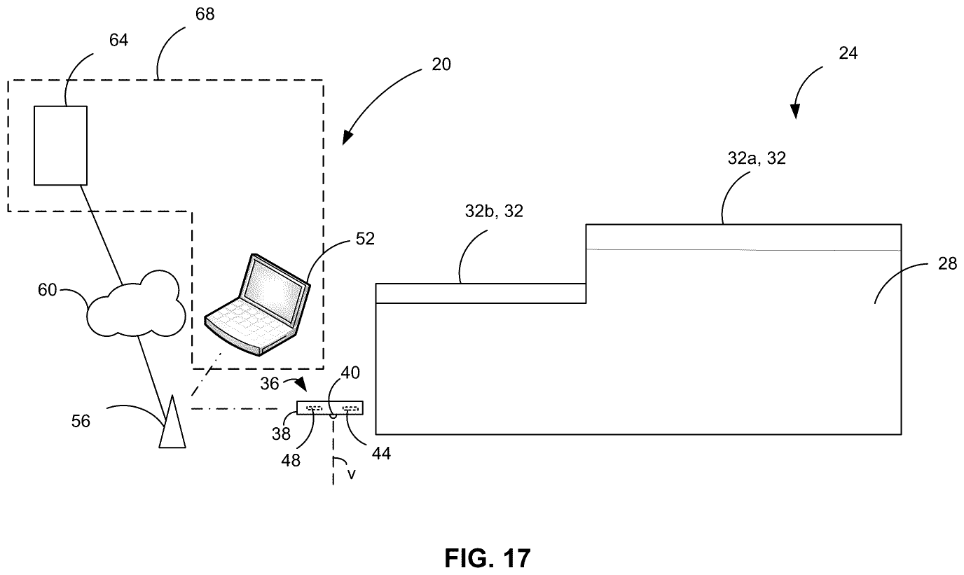

FIG. 17 shows a system for surveying roofing structures and its operating environment in accordance with other exemplary embodiments. In this particular illustrated exemplary embodiment, a portable computing system 52′ is a laptop computer, and the drone 36 is communicates with the portable computing system 52′ and the server computing system 60 via a wireless access point 68. The wireless access point 68 may be permanently or intermittently positioned within wireless communications range of the drone 36 and the site 24. For example, the drone 36 may be positioned near the wireless access point 68 to receive instructions and then subsequently to upload images captured by the drone 36 or can be in constant communication with the wireless access point 68 at the site 24. The wireless access point 68 is connected to the communications network 56 to enable the drone 36 and the portable computing system 52 to communicate with the server computing system 60.

The steps (also referred to as operations) in the flowcharts and drawings described herein are for purposes of example only. There may be many variations to these steps/operations without departing from the teachings of the present disclosure. For instance, the steps may be performed in a differing order, or steps may be added, deleted, or modified, as appropriate.

In other embodiments, the same approach described herein can be employed for other modalities.

### General

Through the descriptions of the preceding embodiments, the present invention may be implemented by using hardware only, or by using software and a necessary universal hardware platform, or by a combination of hardware and software. The coding of software for carrying out the above-described methods described is within the scope of a person of ordinary skill in the art having regard to the present disclosure. Based on such understandings, the technical solution of the present invention may be embodied in the form of a software product. The software product may be stored in a non-volatile or non-transitory storage medium, which can be an optical storage medium, flash drive or hard disk. The software product includes a number of instructions that enable a computing device (personal computer, server, or network device) to execute the methods provided in the embodiments of the present disclosure.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several exemplary embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

Features from one or more of the above-described embodiments may be selected to create alternate embodiments comprised of a sub-combination of features which may not be explicitly described above. In addition, features from one or more of the above-described embodiments may be selected and combined to create alternate embodiments comprised of a combination of features which may not be explicitly described above. Features suitable for such combinations and sub-combinations would be readily apparent to persons skilled in the art upon review of the present disclosure as a whole.

In addition, numerous specific details are set forth to provide a thorough understanding of the exemplary embodiments described herein. It will, however, be understood by those of ordinary skill in the art that the exemplary embodiments described herein may be practiced without these specific details. Furthermore, well-known methods, procedures, and elements have not been described in detail so as not to obscure the exemplary embodiments described herein. The subject matter described herein and in the recited claims intends to cover and embrace all suitable changes in technology.

Although the present invention and its advantages have been described in detail, it should be understood that various changes, substitutions and alterations can be made herein without departing from the invention as defined by the appended claims.

The present invention may be embodied in other specific forms without departing from the subject matter of the claims. The described exemplary embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A method for surveying roofing structures, comprising:
controlling a drone to fly along a first flight path in a direction over roofing structure of a site;
capturing a primary set of images of a first set of regions of the roofing structure of the site during flight of the drone along the first flight path via at least one imaging device of the drone maintained in a first fixed pose relative to the roofing structure;
controlling the drone to fly along a second flight path over the roofing structure;
capturing a secondary set of images of a second set of regions of the roofing structure during flight of the drone along the second flight path via the at least one imaging device of the drone maintained in a second fixed pose relative to the roofing structure;
storing the primary set of images and the secondary set of images in memory of a computing system; and
processing the primary set of images and the secondary set of images via the computing system to identify issues in the roofing structure of the site.

2. The method of claim 1, wherein the drone has a frame that is maintained in a fixed orientation during capture of the primary set of images, and a subset of the at least one imaging device is maintained in fixed orientation relative to the frame.

3. The method of claim 2, wherein the subset of the at least one imaging device is a first subset of the at least one imaging device, wherein the fixed orientation is a first fixed orientation, and wherein a second subset of the at least one imaging device is maintained in a second fixed orientation relative to the frame.

4. The method of claim 1, wherein the at least one imaging device is reorientable, is configured in a first orientation relative to the frame during the first flight path, and is configured in a second orientation relative to the frame during a second flight path.

5. The method of claim 4, wherein the at least one imaging device is oriented downwards during the first flight path and the primary set of images are nadir images, and wherein the at least one imaging device is oriented oblique to a vertical axis during the second flight path.

6. A system for surveying roofing structures, comprising:
a drone having at least one imaging device; and
a computing system having:
at least one processor;
storage storing computer-readable instructions that, when executed by the at least one processor, cause the at least one processor to control the drone to fly along a first flight path in a direction over roofing structure of a site, capture a primary set of images of a first set of regions of the roofing structure of the site during flight of the drone along the first flight path via the at least one imaging device of the drone maintained in a first fixed pose relative to the roofing structure, control the drone to fly along a second flight path over the roofing structure, and capture a secondary set of images of a second set of regions of the roofing structure during flight of the drone along the second flight path via the at least one imaging device of the drone maintained in a second fixed pose relative to the roofing structure.

7. The system of claim 6, wherein the computer-readable instructions, when executed by the at least one processor, cause the computing system to store the primary set of images and the secondary set of images in the storage, and process the primary set of images and the secondary set of images via the computing system to identify issues in the roofing structure of the site.

8. The system of claim 6, wherein the computer-readable instructions, when executed by the at least one processor, cause the computing system to control the drone to maintain a frame of the drone in a fixed orientation during capture of the primary set of images, and maintain a subset of the at least one imaging device i in fixed orientation relative to the frame.

9. The system of claim 8, wherein the subset of the at least one imaging device is a first subset of the at least one imaging device, wherein the fixed orientation is a first fixed orientation, and wherein the computer-readable instructions, when executed by the at least one processor, cause the computing system to control the drone to maintain a second subset of the at least one imaging device in a second fixed orientation relative to the frame.

10. The system of claim 6, wherein the at least one imaging device is reorientable, and is configured in a first orientation relative to the frame during the first flight path, and is configured in a second orientation relative to the frame during a second flight path.

11. The system of claim 10, wherein the at least one imaging device is oriented downwards during the first flight path and the primary set of images are nadir images, and wherein the at least one imaging device is oriented oblique to a vertical axis during the second flight path.

12. A computer-implemented method for surveying roofing structures, comprising:
controlling a drone to fly over a roofing structure of a site;
capturing a set of images of the roofing structure of the site via an imaging device of the drone;
tagging roofing types in each of the set of images; and
processing each image in a subset of the set of images tagged with a specific tag with a machine learning model trained for a corresponding one of the roofing types to identify issues with the roofing structure of the site.
